(19) United States
(12) Patent Application Publication
(10) Pub. No.: US 2012/0151080 A1
(43) Pub. Date: Jun. 14, 2012

(54) Media Repackaging Systems and Software for Adaptive Streaming Solutions, Methods of Production and Uses Thereof

(75) Inventors: Dave Brueck, Saratoga Springs, UT (US); C. Ryan Owen, Riverton, UT (US); Nathan Burr, Pleasant Grove, UT (US); Tyler Bye, Lehi, UT (US); Nathan James Edwards, Provo, UT (US); Ken Brueck, Lehi, UT (US)

(73) Assignees: of California; upLink LLC a limited liability company organized and existing under the laws of the State

(21) Appl. No.: 12/968,140

(22) Filed: Dec. 14, 2010

(51) Int. Cl. G06F 15/16

(52) U.S. Cl. 709/231

(57) ABSTRACT

Dynamic translation systems and methods for converting one adaptive streaming format to another adaptive streaming format are described that include: a) at least one source file, live stream or combination thereof, b) at least one playback device or entity comprising a device format or entity format and an interactive device interface, and c) a translator, wherein the translator progressively converts the at least one source file, live stream or combination thereof to the device format or entity format at the interactive device interface. In some embodiments, these systems include: a) at least one source file, live stream or combination thereof, b) an encoder, wherein the encoder converts the at least one source file, live stream or combination thereof to at least one file comprising a common device format; and c) a content development network, wherein the network stores the at least one file comprising a common device format. In yet other embodiments, these systems include: a) at least one source file, live stream or combination thereof, b) at least one encoder, wherein the encoder converts the at least one source file, live stream or combination thereof to at least one common format file, c) a content development network, wherein the content development network stores the at least one common format file, d) a translator, and e) at least one playback device or entity comprising a device or entity format, wherein the translator progressively provides the at least one common format file to the at least one playback device or entity in the device or entity format.

### FIELD OF THE SUBJECT MATTER

The field of the subject matter is a media repackaging system and related software for adaptive streaming solutions, their methods of production and their uses thereof.

### BACKGROUND

Media production, content providers and distribution companies are at a point in time where development costs are rising, along with public demand for less expensive content. Part of this rise in development costs can be attributed to the fact that content providers must provide multiple formats of the same content, so that the content can be used by different types of computers, handheld devices and other media or content players.

Adaptive streaming is becoming the de facto standard for media streaming on the internet, because of its ability to scale well and to react to ever-changing network conditions on the open internet. A major problem, however, is that the adaptive content must be prepared in a vendor specific format. For example, playback on Apple iOS devices (such as the iPad or iPhone) requires the use of Apple's “HTTP Live Streaming”. These devices do not understand adaptive media in other formats. However, Apple's live streaming format is not understood on or compatible with other platforms that have not adopted Apple's format. For example, Adobe Flash players can play back adaptive streaming content but it needs to be in a format understood by Adobe Flash players, and if it is in that format, then it cannot be played on Apple iOS devices.

Content publishers deal with this problem by encoding their content in multiple formats. Complex encoding systems take as input the content in its original format, and then create a separate output version in each of the desired formats to support various devices and platforms. So, for example, NBC's production unit will need to produce several encoded versions of each of their shows in order to be viewed on different devices with different vendor required formats. Therefore, there would be at least two full copies of one episode of 30Rock, Top Chef or The Rachel Maddow Show that are produced and available on the Internet or another content sharing system.

In order to encode content to multiple formats, significant expense is incurred because the content publishers must pay for encoding time, bandwidth to and from the encoding resources, and for storage of the encoded media. During playback, the caching infrastructure that delivers the content to users has to store each format separately, so the benefit of caching is reduced as the number of different formats increases, and consequently, reduced caching leads to increased transport costs.

Managing content in different formats also adds complexity to the overall process of content management. For example, content rights often dictate when a certain TV show can be watchable and when it must be made unavailable. If the content exists in multiple formats, then the work of making it available initially and removing or deleting it must be done in some coordinated fashion across all the available formats. There may also be issues related to whether the content is available by a free subscription, paid subscription or by the episode.

Another concern that surfaces when multiple formats of the same content is stored on the Internet is that data mining of that information or content is logistically difficult from the standpoint of reporting which content and/or information is in what format.

All of the above-mentioned costs are multiplied when adaptive streaming is used because adaptive streaming typically means that each piece of content is encoded multiple times anyway. For example, a content publisher that wants to make their movies playable on Apple devices and on desktop computers running Adobe Flash may end up encoding each movie many times—5-10 bitrates for Apple streaming and 5-10 more for Flash. The high cost of supporting multiple platforms quickly becomes prohibitive, such that content publishers find it very difficult to monetize the content. Often they end up selecting only certain platforms (thereby limiting their reach) or selecting only certain, popular content (thereby limiting their content library).

It would be ideal if a media company or content provider could produce content in one format, depending on which one is more cost-effective for that company. Then, the content could be delivered and played on any content/media interface based on the ability to be converted to the interface format on the fly or in other words, at the client side of the application—as it is delivered. It is this piece of the puzzle that has not been solved by the media companies or content providers.

### SUMMARY

Dynamic translation systems for converting one adaptive streaming format to another adaptive streaming format are described that include: a) at least one source file, live stream or combination thereof, b) at least one playback device or entity comprising a device format or entity format and an interactive device interface, and c) a translator, wherein the translator progressively converts the at least one source file, live stream or combination thereof to the device format or entity format at the interactive device interface.

In some embodiments, these systems include: a) at least one source file, live stream or combination thereof, b) an encoder, wherein the encoder converts the at least one source file, live stream or combination thereof to at least one file comprising a common device format; and c) a content development network, wherein the network stores the at least one file comprising a common device format.

In yet other embodiments, these systems include: a) at least one source file, live stream or combination thereof, b) at least one encoder, wherein the encoder converts the at least one source file, live stream or combination thereof to at least one common format file, c) a content development network, wherein the content development network stores the at least one common format file, d) a translator, and e) at least one playback device or entity comprising a device or entity format, wherein the translator progressively provides the at least one common format file to the at least one playback device or entity in the device or entity format.

Methods of dynamically translating one adaptive streaming format to another adaptive streaming format are described that include: a) providing at least one source file, live stream or combination thereof, b) providing at least one playback device or entity comprising a device format or entity format and an interactive device interface, and c) providing a translator, wherein the translator progressively converts the at least one source file, live stream or combination thereof to the device format or entity format at the interactive device interface.

In some embodiments, these methods include: a) providing at least one source file, live stream or combination thereof, b) providing an encoder, wherein the encoder converts the at least one source file, live stream or combination thereof to at least one file comprising a common device format; and c) providing a content development network, wherein the network stores the at least one file comprising a common device format.

In yet other embodiments, these methods include: a) providing at least one source file, live stream or combination thereof, b) providing at least one encoder, wherein the encoder converts the at least one source file, live stream or combination thereof to at least one common format file, c) providing a content development network, wherein the content development network stores the at least one common format file, d) providing a translator, and e) providing at least one playback device or entity comprising a device or entity format, wherein the translator progressively provides the at least one common format file to the at least one playback device or entity in the device or entity format.

### BRIEF DESCRIPTION OF THE FIGURES

Prior Art FIG. 1 the conventional method of converting a source file or live stream to encoded formats for each system or playback device.

FIG. 2 shows a contemplated system and method of providing a source file or live stream to a plurality of different playback devices.

FIG. 3 shows a contemplated method as disclosed herein.

### DETAILED DESCRIPTION

As mentioned, it would be ideal if a media company or content provider could produce content in one format, depending on which one is more cost-effective for that company. Then, the content could be delivered and played on any content/media interface based on the ability to be converted to the interface format on the fly—as it is delivered. It is this piece of the puzzle that has not been solved by the media companies or content providers. One reason it is difficult to solve this problem is that new formats are being developed and more established formats keep evolving to meet content demands.

The obvious and ideal solution would be to adopt a standard format for adaptive streaming, which would be similar to producing all high definition content in Blu-Ray format. Each application directed to consumer content would implement one chosen standard, and content would be encoded according to that standard. So far, however, no real consensus has emerged and instead multiple formats continue to be brought forward.

A few companies, such as Apple, have publicly documented their format, but it has not gained much traction outside of Apple as a standard to adopt. Part of the problem is that the companies with their own standards are competitors, so they don't show much interest in adopting each others' format. For example, Apple has very publicly gone against Adobe Flash-related technologies, so it is unlikely that in the near term they will add support for Flash adaptive streaming. Similarly, it is unlikely that Adobe will adopt Apple's format. To further reduce the likelihood of a standard, it appears that some formats are being used to tie customers to a particular platform (i.e. Adobe has a vested interest in getting people to use their format as it ensures sales of their tools and encoders).

Dynamic translation systems for converting one adaptive streaming format to another adaptive streaming format are described that include: a) at least one source file, live stream or combination thereof, b) at least one playback device or entity comprising a device format or entity format and an interactive device interface, and c) a translator, wherein the translator progressively converts or translates the at least one source file, live stream or combination thereof to the device format or entity format at the interactive device interface. As used herein, the phrases “progressively translates” or “progressively converts” are used interchangeably and mean that the file or plurality of files are converted from one format to another at the client or playback device side. Progressive translation is distinguished from conventional encoding in that conventional encoding produces a file in a particular format, so that it can be stored on a network until it is accessed by a device that reads that specific format. Progressive translation or conversion means that the file is produced in one format and then translated or converted into the device or entity format at the device or entity interactive device interface.

The at least one source file, live stream or combination thereof comprises any suitable media content, such as audio content, video content, interactive media content or a combination thereof. The at least one playback device or entity may comprise any suitable playback device or entity, such as a desktop computer, a laptop computer, a handheld device, a freestanding computer or monitor (such as a flat panel TV), a projection system, an interactive projection system or a combination thereof. Some contemplated playback devices, for example, include an iPod, an iPad, a Droid, a laptop computer and/or a Blackberry device. A contemplated device format or entity format comprises any suitable future and/or contemporary format, including such contemporary formats as Apple Live Streaming format or Adobe Flash format. A contemplated “common device format” is one device format that is considered usable by most, if not all, playback devices or entities once progressive translation or progressive conversion occurs.

In some embodiments, these systems include: a) at least one source file, live stream or combination thereof, b) an encoder, wherein the encoder converts the at least one source file, live stream or combination thereof to at least one file comprising a common device format; and c) a content development network, wherein the network stores the at least one file comprising a common device format. In these embodiments, the at least one file comprising a common device format is stored until it is “demanded” by a playback device or suitable entity where it is either directly transferred to the playback device or entity, if the playback device or entity supports common device format, or progressively translated at the interactive device interface from the common device format into device or entity format. A contemplated content development network may be any suitable network where content can be stored, developed and shared, such as a Cloud system or Cloud architecture, a file sharing system, a file swapping system or a combination thereof. A contemplated content development network may also comprise the translator or the at least one translator. In yet other embodiments, the content development network may comprise the translator or the at least one translator, the library or the at least one library of the at least one common format file or a combination thereof. The at least one translated file may be stored on the playback device and/or entity.

In yet other embodiments, these systems include: a) at least one source file, live stream or combination thereof, b) at least one encoder, wherein the encoder converts the at least one source file, live stream or combination thereof to at least one common format file, c) a content development network, wherein the content development network stores the at least one common format file, d) a translator, and e) at least one playback device or entity comprising a device or entity format, wherein the translator progressively provides the at least one common format file to the at least one playback device or entity in the device or entity format.

Right now, as shown in Prior Art FIG. 1, a conventional system 100 of preparing source files or live streams for playback on individual devices has to go through several, and now unnecessary, steps. The source file or live stream 110 is sent to and passed through several different encoders 120, where each encoder is responsible for converting the source file or live stream 110 to a particular format 130. Each of these individual formats 130 is stored separately on a content delivery network or CDN 140, such as a cloud architecture. Each of these individual formats 130 is stored on the CDN 140 until it is accessed by a network server, subscription system, the internet, a particular device or computer, a file sharing system or a combination thereof 150. From reviewing this conventional system, it should be clear that there are several disadvantages. First, several different encoders must be utilized and maintained to convert the source file or live stream to a particular individual format. Second, each of these individual formats must be stored on the CDN. Third, if one format eventually emerges as the “common format”, the other formatted copies will continue to exist on the CDN and probably will continue to be made available to older devices, until these devices are all phased out of use.

After reviewing the state of the art, it is clear that solving the problem on the content production side appears to be an impossible undertaking. Therefore, these problems must be solved, and now have been solved, on the client side of the media transmission/download.

Although a standard adaptive streaming format has emerged, two underlying commonalities have been discovered that can be used to achieve the same ends. They are:
Codecs—H.264 (for video) and AAC (for audio) are commonly regarded as the best codecs to use. For example, companies that encode their content for both Flash and iOS devices may put the content into two different formats, but use H.264/AAC in both cases.
Segmentation—the current best practices for adaptive streaming involve slicing content into discrete chunks of media that are delivered over HTTP and then reassembled into a continuous media stream during playback.

By taking advantage of this common ground, a solution has been developed that addresses all of the adaptive streaming multi-format problems without requiring a standard adaptive streaming format.

Ultimately, the differences in the adaptive streaming formats are differences in packaging. More specifically, although the approaches to segmentation and delivery may differ somewhat, there is enough common ground across the various formats that it is possible, and contemplated in some embodiments, to encode media in one format and then repackage it into a different format, where the repackaging process is sufficiently lightweight that it can be done in real time inside the consuming application (i.e. in the client or on the client side of the transmission). The repackaging is much less costly in terms of CPU than transcoding from one codec to another.

One drawback to the approach of repackaging from one vendor's format to another is that each vendor appears to primarily have only their own interests in mind and therefore was less concerned about a universal format. For example, Apple probably doesn't care very much if their streaming format is easily playable on Flash. Similarly, Adobe was probably focused more on making a solution that is convenient for them and on a solution that would reinforce the need to buy Flash encoders and tools, and less concerned about being compatible with Apple Quicktime.

Therefore, each adaptive streaming format has sub-optimal characteristics when approaching the problem from the perspective of universal playback. For example, Apple's use of MPEG-2 transport streams means the Flash library that repackages from Apple to Flash format must be quite complex, because the MPEG-2 format is itself complex. Further, the transport stream format was originally targeted for use over unreliable networks and therefore using that format incurs significant overhead, because it includes a lot of additional metadata for use in error detection and correction and packetization. Current adaptive streaming, however, happens over HTTP which is built on top of TCP/IP which guarantees reliable transmission without the need of additional packetization or major error detection.

Another contemplated approach is to introduce a new, open adaptive streaming format that is not specific to any particular vendor, but instead takes into consideration the needs of multiple platforms. Content would be encoded into this common format, and then libraries would be written for each platform to repackage from the common format into the platform-specific format. For example, on a contemplated iOS device, a library would download media slices in the common format and dynamically repackage them into MPEG-2 transport stream files playable by Quicktime. As before, this common format would use the standard codecs (H.264/AAC currently) so that the data can be repackaged (the cheap operation) and not transcoded (the prohibitively expensive operation).

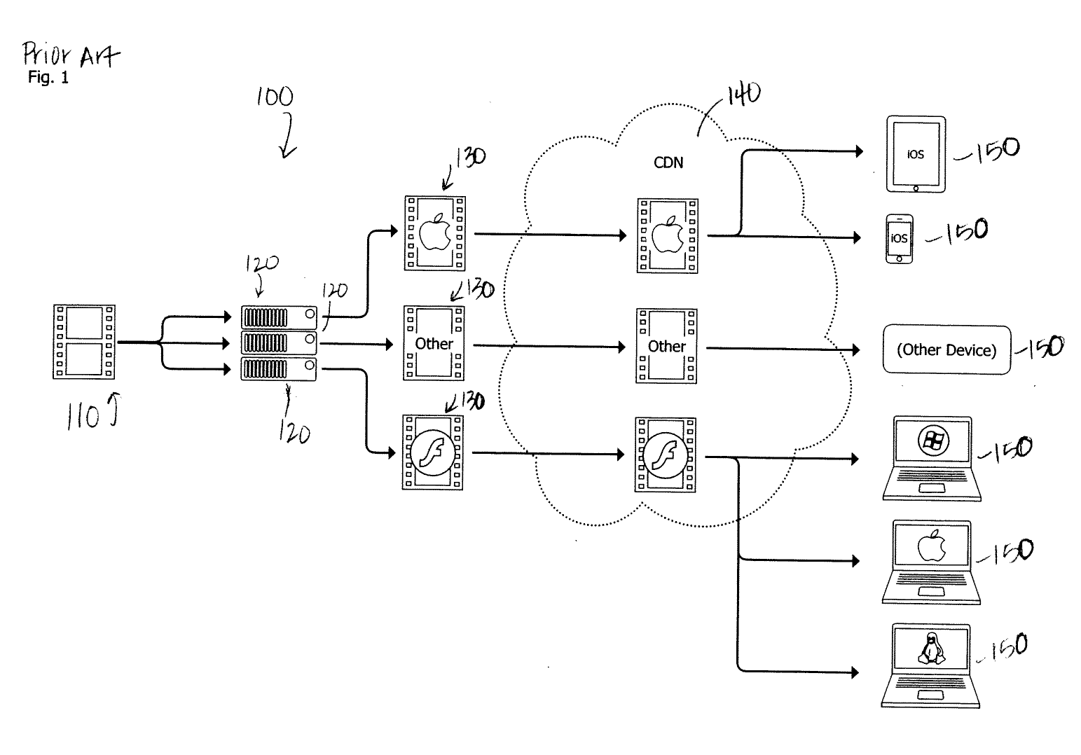

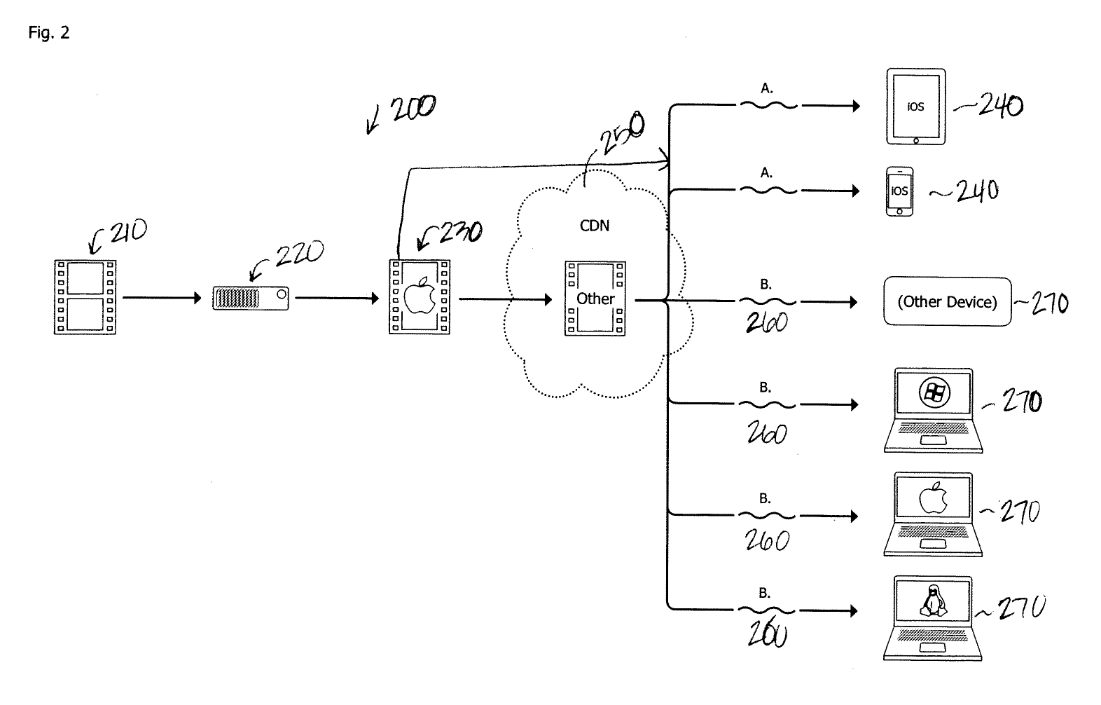

This contemplated system 200 is shown in FIG. 2, where a source file or live stream 210 is encoded 220 into either one of the Apple/Adobe formats or a common format 230. If this format is the Apple or Adobe format, it can then be directly delivered to those devices 240 that utilize that format without any additional conversion. If the source file or live stream 210 is converted into a common format 230, then that one copy is stored into a translation library on the CDN 250 where it can be converted on the client device side of the transmission 260 for any of the client-side devices or demand-side entities 240 and 270.

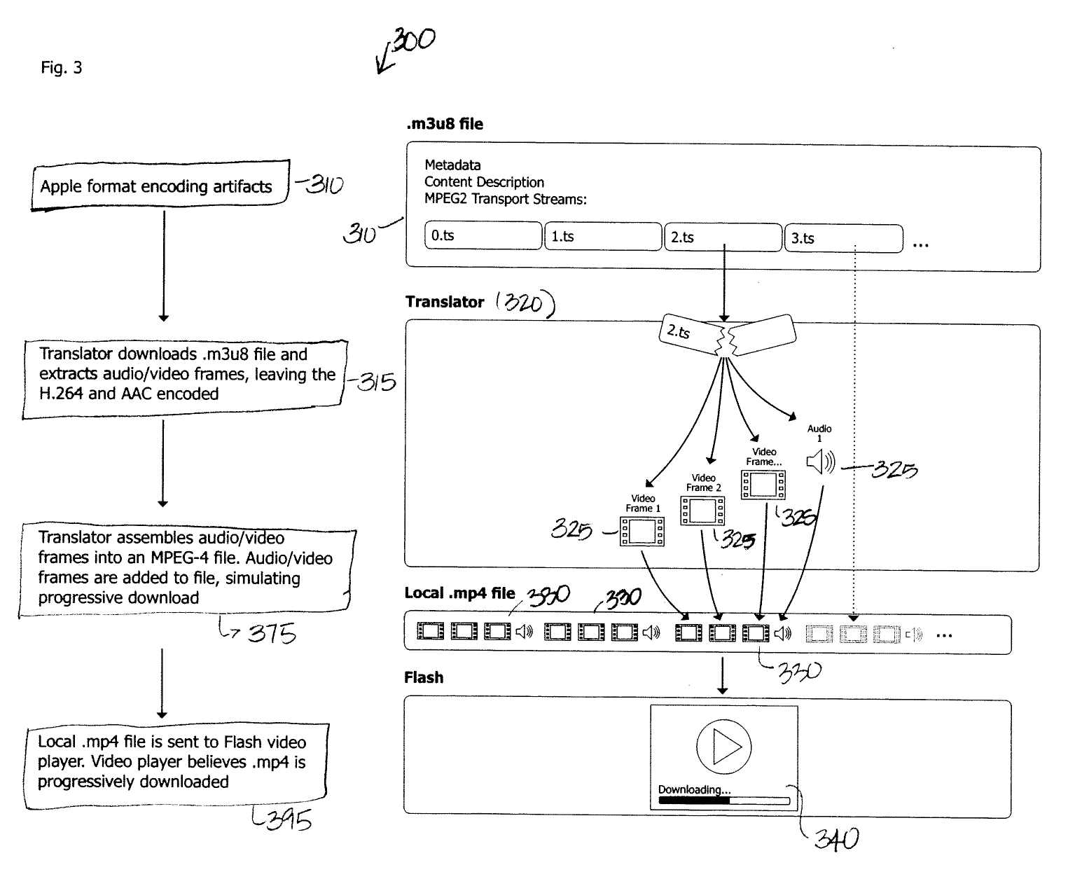

If the common format gains traction, then future versions of each platform could add native support for the common format, eliminating the need for the repackaging library on that platform. In other words, this approach not only provides a good interim solution but also can be the first step towards the ideal solution. The solution should work with any number of adaptive streaming solutions, can work independent of codec (as in, it doesn't require H.264/AAC in and of itself but just makes use of them because that's what everybody else is using), and would work with both live and pre-recorded content. FIG. 3 shows, along with Example 1, an example of how a contemplated system 300 would work. Apple format encoding artifacts and artifact files 310 are downloaded 315 to a translator 320 that then extracts audio and/or video frames 325 while leaving the H.264 and AAC codecs encoded. It should be understood that any video and/or audio codecs can be used in the frames and that they don't necessarily have to be H.264 or AAC codecs. Any suitable codecs or programs for audio and video are contemplated, such as video codecs, video programs, audio codecs, audio programs or a combination thereof. The translator 320 then assembles 375 the audio and/or video frames 325 into, in this case, a MPEG-4 file 330 simulating a progressive download. The local .mp4 file 335 is sent 395 to the Adobe Flash video player 340. The video player 340 “believes” or considers that the .mp4 file is being progressively downloaded.

In both Example 1 and Example 2 presented herein, because the content is presented to the respective platforms in an apparently native format, playback would automatically take advantage of hardware acceleration when present. For example, Apple's devices support hardware-accelerated H.264/AAC decoding and hardware-accelerated rendering, but the Apple development SDK does not expose direct access to hardware-accelerated functionality, such that it is not available to third party developers. So, other solutions have had to rely on software decoding and rendering, which is many times more expensive to do, thus resulting in drastically reduced battery life. The approach contemplated and disclosed herein, which repackages the content into Apple format, automatically takes advantage of hardware-accelerated decoding and rendering because the platform believes it is playing normal Apple content.

The hardware-acceleration benefits work on other platforms as well. For example, the Flash player on desktop computers uses hardware-accelerated rendering if possible, and as before this functionality is not directly available to developers. By dynamically repackaging the media into the native Flash format, however, playback automatically uses the hardware acceleration features.

Methods of dynamically translating one adaptive streaming format to another adaptive streaming format include: a) providing at least one source file, live stream or combination thereof, b) providing at least one playback device or entity comprising a device format or entity format and an interactive device interface, and c) providing a translator, wherein the translator progressively converts the at least one source file, live stream or combination thereof to the device format or entity format at the interactive device interface.

In some embodiments, these methods include: a) providing at least one source file, live stream or combination thereof, b) providing an encoder, wherein the encoder converts the at least one source file, live stream or combination thereof to at least one file comprising a common device format; and c) providing a content development network, wherein the network stores the at least one file comprising a common device format.

In yet other embodiments, these methods include: a) providing at least one source file, live stream or combination thereof, b) providing at least one encoder, wherein the encoder converts the at least one source file, live stream or combination thereof to at least one common format file, c) providing a content development network, wherein the content development network stores the at least one common format file, d) providing a translator, and e) providing at least one playback device or entity comprising a device or entity format, wherein the translator progressively provides the at least one common format file to the at least one playback device or entity in the device or entity format.

### EXAMPLES

### Example 1

### Apple-Encoded Original Format

Content can be encoded according to Apple's HTTP Live Streaming format, which supports slices of media to be stored as H.264/AAC media in MPEG-2 transport stream files. By encoding in this format, the content is automatically playable on any iPad, iPhone, or iPod Touch device. It is not, however, playable on Android mobile devices, desktop computers running Adobe Flash, etc.

Adobe Flash supports playback of H.264/AAC files in MPEG-4 format. A library inside an Adobe Flash SWF file would be created that knows how to “speak” both the Apple and Flash formats. This library would successively download Apple MPEG-2 transport stream files and repackage them on-the-fly into MPEG-4 format and then deliver the MPEG-4 data to the native Flash video playback component, presenting it in such a way that the Adobe Flash player thinks it is playing one large, progressively-downloaded MPEG-4 file.

### Example 2

### Adobe-Encoded Original Format

Original content could be encoded in the Adobe Flash format. In this scenario, a library inside an iOS application would download the individual slices of Flash media and repackage them on the fly into MPEG-2 transport streams at the “client side” of the device. Apple Quicktime, the component that plays the media, would see the media as valid Apple HTTP Live Streaming content and play it normally.

Thus, specific embodiments and applications of media repackaging systems and software for adaptive streaming solutions, methods of production and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A dynamic translation system for converting one adaptive streaming format to another adaptive streaming format, comprising:
at least one source file, live stream or combination thereof,
at least one playback device or entity comprising a device format or entity format and an interactive device interface, and
a translator, wherein the translator progressively converts the at least one source file, live stream or combination thereof to the device format or entity format at the interactive device interface.

2. The dynamic translation system of claim 1, wherein the at least one source file, live stream or combination thereof comprises media content.

3. The dynamic translation system of claim 2, wherein media content comprises audio content, video content, interactive media content or a combination thereof.

4. The dynamic translation system of claim 1, wherein the at least one playback device or entity comprises a desktop computer, a laptop computer, a handheld device, a freestanding computer or monitor, a projection system, an interactive projection system or a combination thereof.

5. The dynamic translation system of claim 1, wherein the device format or entity format comprises Apple Live Streaming format or Adobe Flash format.

6. A dynamic translation system for converting one adaptive streaming format to another adaptive streaming format, comprising:
at least one source file, live stream or combination thereof,
an encoder, wherein the encoder converts the at least one source file, live stream or combination thereof to at least one file comprising a common device format; and
a content development network, wherein the network stores the at least one file comprising a common device format.

7. The dynamic translation system of claim 6, further comprising at least one playback device or entity comprising a device format or entity format and an interactive device interface.

8. The dynamic translation system of claim 7, wherein the at least one file comprising a common device format is transferred to the at least one playback device or entity through the interactive device interface.

9. The dynamic translation system of claim 8, wherein the at least one file comprising a common device format is translated from the common device format into the device format or entity format at the interactive device interface to form at least one translated file.

10. The dynamic translation system of claim 9, wherein the at least one translated file is stored on the device or entity.

11. The dynamic translation system of claim 6, wherein the content development network is a Cloud system, file sharing system, file swapping system or a combination thereof.

12. A dynamic translation system for converting one adaptive streaming format to another adaptive streaming format, comprising:
at least one source file, live stream or combination thereof,
at least one encoder, wherein the encoder converts the at least one source file, live stream or combination thereof to at least one common format file,
a content development network, wherein the content development network stores the at least one common format file,
a translator, and
at least one playback device or entity comprising a device or entity format, wherein the translator progressively provides the at least one common format file to the at least one playback device or entity in the device or entity format.

13. The system of claim 12, wherein the at least one source file, live stream or combination thereof comprises at least one codec or program.

14. The system of claim 13, wherein the at least one codec or program comprises a video codec, video program, audio codec, audio program or a combination thereof.

15. The system of claim 12, wherein the content development network comprises cloud architecture.

16. The system of claim 12, wherein the content development network comprises the translator.

17. The system of claim 12, wherein the content development network comprises the translator, a library of the at least one common format file or a combination thereof.

18. A method of dynamically translating one adaptive streaming format to another adaptive streaming format, comprising:
providing at least one source file, live stream or combination thereof,
providing at least one playback device or entity comprising a device format or entity format and an interactive device interface, and
providing a translator, wherein the translator progressively converts the at least one source file, live stream or combination thereof to the device format or entity format at the interactive device interface.

19. The method of claim 18, wherein the at least one source file, live stream or combination thereof comprises media content.

20. The method of claim 19, wherein media content comprises audio content, video content, interactive media content or a combination thereof.

21. The method of claim 18, wherein the at least one playback device or entity comprises a desktop computer, a laptop computer, a handheld device, a freestanding computer or monitor, a projection system, an interactive projection system or a combination thereof.

22. The method of claim 18, wherein the device format or entity format comprises Apple Live Streaming format or Adobe Flash format.
